(19) United States
(12) Patent Application Publication
(10) Pub. No.: US 2008/0193820 A1
(43) Pub. Date: Aug. 14, 2008

(54) Method for fabricating proton exchange membrane having relational selective coefficient

(75) Inventors: Hwei-Lang Chang, Taoyuan County (TW); Chen-Si Tsao, Taoyuan County (TW); Hen-Rong Chang, Pingzhen City (TW); Kuo-Lon Shieh, Taoyuan County (TW); Pi-Hsin Cheng, Zhongli City (TW)

Correspondence Address: TROXELL LAW OFFICE PLLC, 5205 LEESBURG PIKE, SUITE 1404, FALLS CHURCH, VA, 22041, US

(73) Assignee: ATOMIC ENERGY COUNCIL-INSTITUTE OF NUCLEAR ENERGY RESEARCH, Taoyuan (TW)

(21) Appl. No.: 11/704,379

(22) Filed: Feb. 9, 2007

(51) Int. Cl. H01M 8/00

(52) U.S. Cl. 429/33

(57) ABSTRACT

A proton exchange membrane (PEM) is made. The PEM has a high relational selective coefficient. This means the PEM of the present invention can better confine methanol yet still remains good methanol conducting capacity. The present invention has an easy fabrication process with no additional material needed. And the present invention can be used in a fuel cell like DMFC or H01M008/10.

### FIELD OF THE INVENTION

The present invention relates to fabricating a proton exchange membrane (PEM); more particularly, relates to using a PEM having sulfonic acid group (—SO₃H) as an end group of a branch chain; or a precursor having sulfonamide fluoride group (—SO₂F) as an end group of a branch chain to be processed through an ionizing radiation to obtain a PEM having improved methanol barring and increased relational selective coefficient, which is suitable for Direct Methanol fuel cell.

### DESCRIPTION OF THE RELATED ARTS

A general proton exchange membrane fuel cell (PEMFC) having a polymer film does not conquer the difficulties in storing and transporting its fuel. Yet, a direct methanol fuel cell (DMFC) is easy in storing and transporting its fuel, so it becomes a potential to share or even replace the market of PEMFC. However, DMFC has key technologies for improving which relate to catalyst improvement, and methanol confinement of PEM. PEM in the market (like Nafion series by Du Pont Co.) usually do not have a good methanol confinement; and so too much methanol at the fuel-side electrode (anode) passes through the PEM to the gas-side electrode (cathode). Such a situation causes the following big problems: (i) fuel waste; (ii) cathode catalyst poisoning; and (iii) mixed potential power loss.

To make things better, the following methods are used: (1) adding a confining layer: (2) using a combined film; (3) grafting a co polymer; and (4) using a polymer of high-temperature phosphorous and nitrogen compound or aromatic hydrocarbon having a main ring chain. Results of these methods usually improves methanol barring while diminishes proton conductivity. In order to maintain methanol barring without sacrificing proton conductivity, relational selective coefficient becomes another standard for evaluating the PEM for DMFC. The relational selective coefficient is a product of proton conducting coefficient and methanol barring coefficient relating to those of an original material. A higher relational selective coefficient means a better methanol barring coefficient as well as proton conducting coefficient.

Regarding the confining layer, the combined film and the graft copolymer, related materials have to be added to the original PEM, which makes the process complex. Regarding the polymer of high-temperature phosphorous and nitrogen compound or aromatic hydrocarbon having a main ring chain, the original material is different and the film made is only suitable to be operated under high temperature for proton conducting. Hence, the prior arts do not fulfill users' requests on actual use.

### SUMMARY OF THE INVENTION

The main purpose of the present invention is to provide a PEM having improved methanol barring, an increased relational selective coefficient and a simplified fabrication method.

To achieve the above purpose, the present invention is a method for fabricating a PEM having a relational selective coefficient, where an ionizing radiation of gamma ray having a dose of 0.1 to 50 kGy is processed to a PEM or a precursor of a yet-ionized PEM; the irradiated precursor is processed through an ionization with an alkaline washing a water washing and an acid washing to obtain a PEM having increased methanol barring; the PEM is a fluorocarbon polymer; the fluorocarbon polymer has a sulfonnic acid group as an end group of a branch chain; the precursor is an intermediate product on fabricating the fluorocarbon polymer and has an end group of a branch chain which is sulfonamide fluoride group (—SO₂F), sulfonamide chloride group (—SO₂Cl or sulfonamide bromide group (—SO₂ Br); the alkaline washing is to soak or wash with a solution having an alkali metal hydroxide; the acid washing is to soak or wash with a solution having an inorganic strong acid of sulfuric acid (H₂SO₄), nitric acid (HNO₃) or hydrochloric acid (HCl); and the present invention is applied to DMFC or H01M008/10 fuel cell with improved methanol barring, easy fabrication and no additional material required. Accordingly, a novel method for fabricating a PEM having a relational selective coefficient is obtained.

### BRIEF DESCRIPTIONS OF THE DRAWINGS

The present invention will be better understood from the following detailed descriptions of the preferred embodiments according to the present invention, taken in con junction with the accompanying drawings, in which

FIG. 1 is the flow view showing the first preferred embodiment according to the present invention;

FIG. 2 is the view showing the PEM having a relational selective coefficient;

FIG. 3 is the flow view showing the second preferred embodiment;

FIG. 4 is the view showing the methanol conducting device; and

FIG. 5 is the view showing the comparison of the relational elective coefficients.

### DESCRIPTION OF THE PREFERRED EMBODIMENTS

The following descriptions of the preferred embodiments are provided to understand the features and the structures of the present invention.

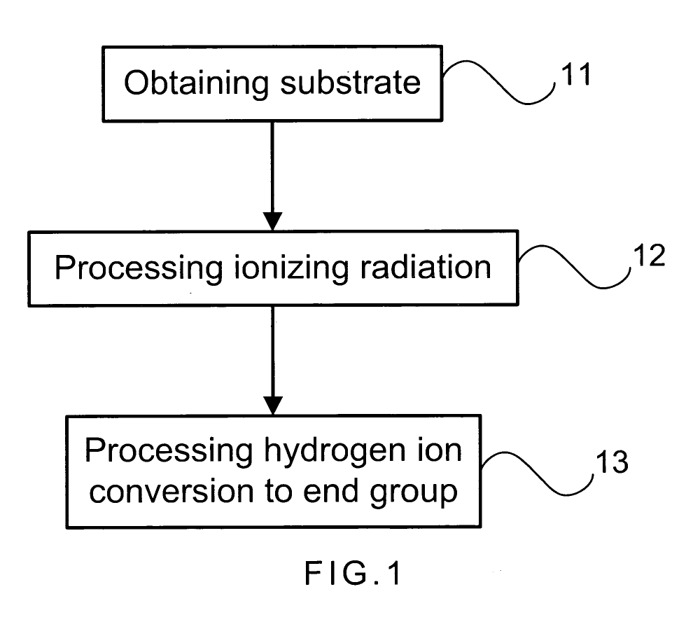

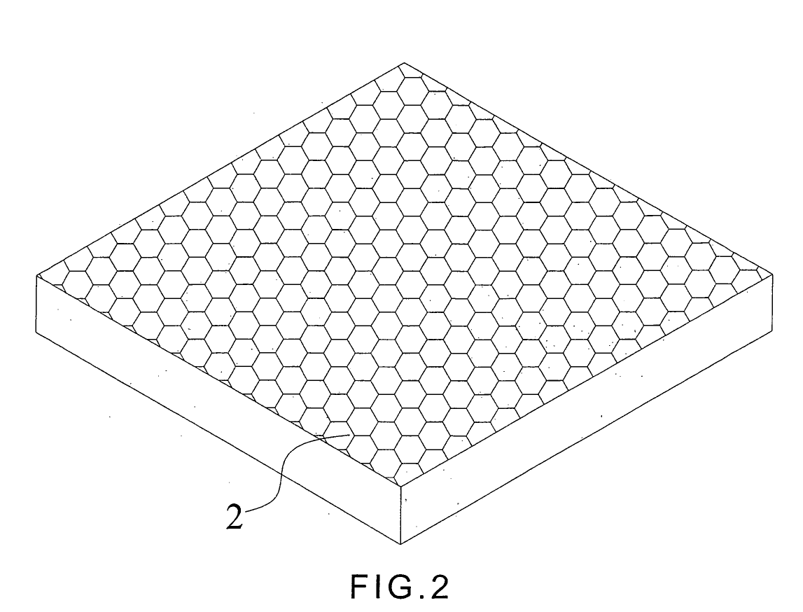

Please refer to FIG. 1 and FIG. 2 which are a flow view showing the first preferred embodiment and a view showing a proton exchange membrane (PEM) having a relational selective coefficient according to the present invention. As shown in the figures, the present invention is a method for fabricating a proton exchange membrane, comprising the following steps:

(a) Obtaining substrate 11: A substrate of a precursor made of a fluorocarbon polymer is obtained, where the precursor is an intermediate product on fabricating the fluorocarbon polymer; the fluorocarbon polymer has an end group of a branch chain; and the end group is a sulfonamide fluoride group (—SO₂F), a sulfonamide chloride group (—SO₂Cl) or a sulfonamide bromide group (—SO₂ Br).

(b) Processing ionizing radiation 12: The substrate is processed through an ionizing radiation, where the ionizing radiation has a total radiation dose less than 50 kilo-grays (kGy); the ionizing radiation has an irradiation rate less than 5 kGy per hour (kGy/hr); and the ionizing radiation uses X ray or gamma ray, which can be cobalt-60 (Co-60) gamma ray.

(c) Processing hydrogen ion conversion to end group 13: The substrate is processed through a hydrogen ion conversion with an alkaline washing, a water washing and an acid washing to convert the end group of a sulfonamide fluoride group into the end group of a sulfonic acid group (—SO₃H) to obtain a PEM 2 having a relational selective coefficient. Therein, the alkaline washing uses an alkali metal hydroxide for soaking or washing; and the acid washing uses an inorganic strong acid of sulfuric acid (H₂SO₄), nitric acid (HNO₃) or hydrochloric acid (HCl) for soaking or washing.

The substrate is Nafion R1100 having a sulfonamide fluoride group, which is pressed by a hot roller or a hot pressor between 180 Celsius degrees (° C.) into a film having a thickness of 0.18 millimeter (mm).

The ionizing radiation comprises the following steps: (i) the Nafion R1100 film is cut into a piece of 5 cm (centimeter)×5 cm; (ii) the film is put into a polyethylene (PE) zip-lock bag; and (iii) the film is irradiated by a gamma ray. When the radiation dose reaches 100 kGy, the film is apt to be worn out. Hence, the maximum radiation dose for the present invention is 50 kGy.

The hydrogen ion conversion comprises the following steps: (i) the irradiated Nafion R1100 film is washed with pure water; (ii) the film is soaked in a solution under 80° C. for two hours (hr), where the solution comprises 15% potassium hydroxide (KOH), 35% Dimethyl sulfoxide (DMSO) and 50% water (H₂O); and the soaking is repeated with the solution refreshed for at least two times; (iii) the film is washed with a deionized pure water and is soaked under 80° C. in the water for 30 minutes (min), and this step is repeated for at least two times; (iv) the film is soaked in a solution having 15% HNO₃ under 80° C. for 1 hr and then is washed, and this step is repeated at least three times to ensure the conversion of the end group from sulfonamide fluoride group into sulfonic acid group.

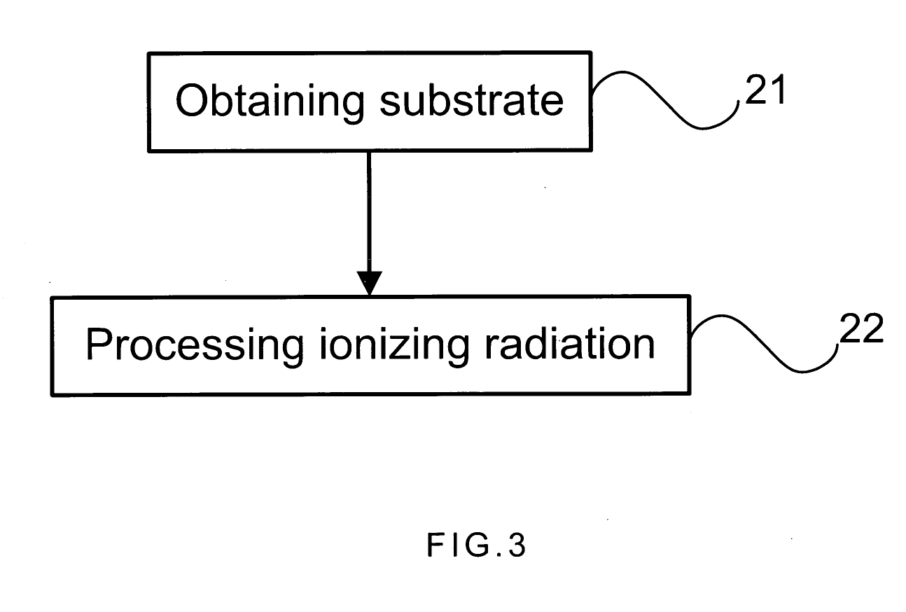

Please refer to FIG. 3 and FIG. 2, which are a flow view showing a second preferred embodiment; and the view showing the PEM having a relational selective coefficient. As shown in the figures, a second embodiment according to the present invention comprises the following steps:

(a) Obtaining substrate 21: A substrate of a fluorocarbon polymer having an end group of a branch chain is obtained, where the end group is a sulfonic acid group (—SO₃H).

(b) Processing ionizing radiation 22: The substrate is processed through an ionizing radiation to obtain a PEM 2 having a relational selective coefficient, where the ionizing radiation has a total radiation dose less than 50 kGy; the ionizing radiation has an irradiation rate less than 5 kGy/h r; and the ionizing radiation uses X ray or gamma ray, which can be Co-60 gamma ray. Thus, a PEM 2 having a relational selective coefficient is obtained.

The substrate is Nafion 117 having a sulfonamide fluoride group, which is pressed between 180° C. by a hot roller or a hot pressor into a film having a thickness of 0.18 mm.

The ionizing radiation comprises the following steps: (i) the Nafion R1100 film is cut into a piece of 5 cm×5 cm; (ii) the film is put into a PE zip-lock bag; and (iii) the film is irradiated by a gamma ray.

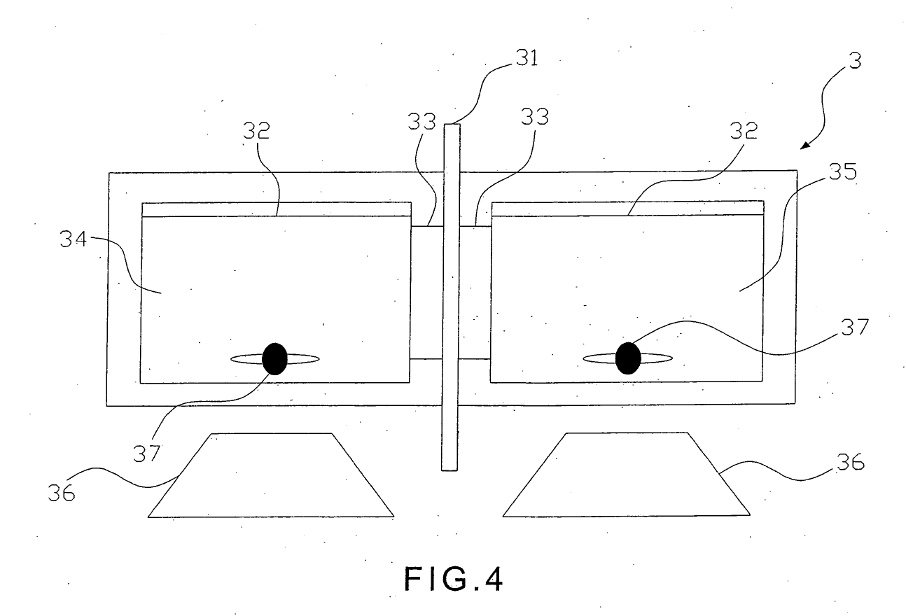

Please refer to FIG. 4, which is a view showing a methanol conducting device. As shown in the figure, a diffusion function of a PEM is measured according to a method by T. A. Zawodzinski, Jr for proton conducting coefficients of irradiated films of Nafion R1100 and Nafion 117 and non-irradiated films of Nafion 117. The proton conducting coefficients are measured with an alternating-current (AC) impedance under a 90% relative humidity (RH) and a 50° C. temperature.

The irradiated films of Nafion R1100 and Nafion 117 and the non-irradiated films of Nafion 117 are washed with deionize water twice and are soaked in the water for one day. The films are taken out and are clipped together with a clip to be put into a constant temperature humidistat made by Yeow Long Co. for one day. Hence, a balance between the film sand the environment in temperature is achieved. Then the clip is connected with the AC impedance, which is Parstat 2263 by Princeton Applied Research, to measure impedances at high frequency and to figure out proton conducting coefficients of irradiated films of Nafion R1100 and Nafion 117 and non-irradiated films of Nafion 117 according to the method by T. A. Zawodzinski, Jr.

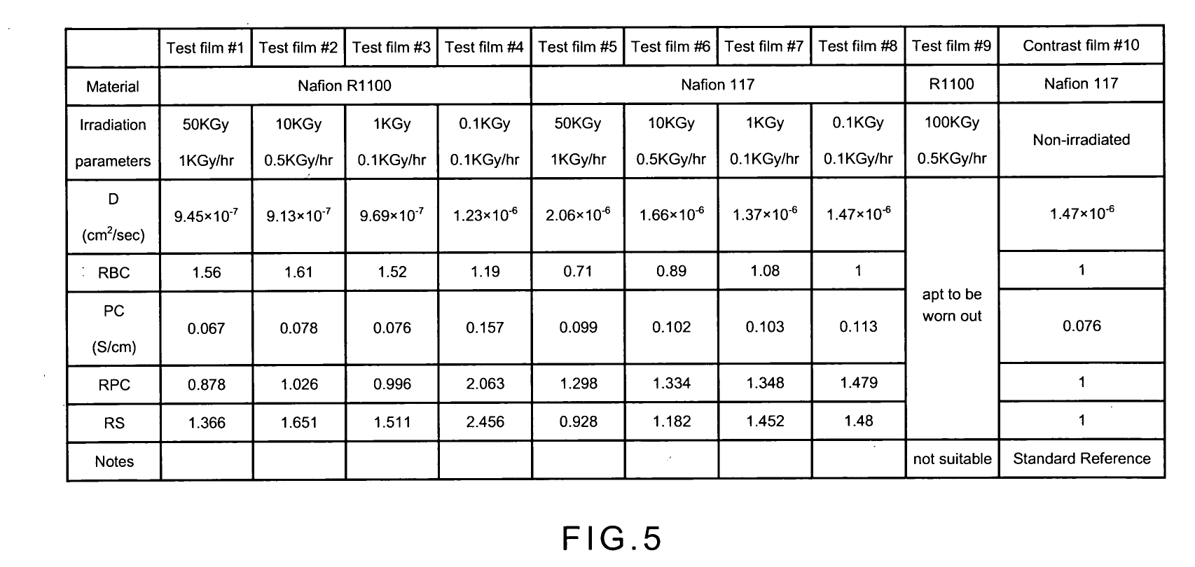

Please refer to FIG. 5, which is a view showing a comparison of relational selective coefficients. As shown in the figure, relational selective coefficients of irradiated films of Nafion R1100 and Nafion 117 and non-irradiated films of Nafion 117 are ratios of proton conducting coefficients of irradiated films of Nafion R1100 and Nafion 117 and non-irradiated films of Nafion 117 (PC_{irradiated Film}) to the proton conducting coefficient of non-irradiated films of Nafion 117 (PC_{Non-irradiated Film}), whose formula are expressed as follows:

$$R P C = \frac{{PC}_{IrradiatedFilms}}{{PC}_{Non \text{-} irradiatedFilms}} \qquad ( formula \#1 )$$

When a proton conducting coefficient is bigger, protons pass through a film easier; on the contrary, the smaller, the harder. On the occasion when a relational selective coefficient is smaller than 1, it is harder for the protons to pass through a film than to pass through Nafion 117.

The irradiated films of Nafion R1100 and Nafion 117 and the non-irradiated films of Nafion 117 are obtained as test films 31 separately to be put between two methanol conducting devices 3 having a 75 c.c. (cubic centimeters) solution level 32. Each test film 31 is clipped between two end surfaces by two end plates of the methanol conducting devices 3 separately, where each of the end plates has an opening having a 4 cm diameter. The solution at left side 34 is a water solution contains 2% n-butanol (a standard solution for a gas chromatography (GC) concentration analysis) and the solution at right side 35 is a water solution contains 10% methanol and 2% n-butanol. After being stirred by a Teflon magnetic stir bar 13 with a magnetic stirrer 36 for a period of time, because the solution at the right side has a higher ratio of methanol, the methanol crosses over the test film to be diffused into the solution at the left side. Between intervals of a certain period of time, the solution sat the two sides are obtained at a quantity of 1 micro-liter (μl) separately for a GC process with a reference to an absorption peak are a of a standard methanol/n-butanol solution to obtain a relationship between a methanol concentration and time. With the data of methanol concentration and time, a methanol diffusion coefficient (D) is obtained according to Fick's diffusion law. The corresponding mathematical equation for this case is as follows:

$$ln ( 1 - \frac{C}{Co / 2} ) = ( - 2 AD / V θ ) t \qquad formula \#2$$

Therein, C is a methanol concentration measured; C₀ is an initial concentration at the diffusing side; V is a volume of the methanol solution; A is a diffusion are a of the test film; θ is a thickness of the test film; and, D is the methanol diffusion coefficient of the test film.

For comparing methanol confining capabilities of test films, the non-irradiated Nafion 117 is used as a referring standard and a relational barring coefficient (RBC) is defined as a reciprocal of a ratio of a methanol diffusion coefficient of an irradiated film of Nafion R1100 or Nafion 117 (D_{Test Film}) to a methanol diffusion coefficient of a non-irradiated film of Nafion 117 (D_{Non-irradiated Film}), whose formula is shown as follows:

$$R B C = \frac{{D}_{Non - irradiatedFilm}}{{D}_{TestFilm}} \qquad formula \#3$$

A bigger relational barring coefficient means a better methanol barring capability; on the contrary, the smaller, the worse. On the occasion when a relational barring coefficient is smaller than 1, the test film having the methanol barring coefficient has a worse methanol barring capability than that of Nafion 117.

The relational selective coefficient (RS) of a test film is a product of its proton conducting coefficient and methanol barring coefficient relating to those of Nafion 117, whose formula is shown as follows:

RS=RPC×RBC formula#4

A bigger relational selective coefficient means a better combination of methanol barring and proton conductivity.

Test film #1 is irradiated with a Co-60 gamma ray, which has an irradiation rate, of 1 kGy/hr, an irradiation time of 50 hr and a total irradiating dose of 50 kGy and the following data are obtained: PC=0.067 S/cm, RPC=0.878, D=9.45×10⁻⁷ cm²/sec, RBC=1.56 and RS=1.366. On comparing to contrast film #10 of a non-irradiated Nafion 117 its relational barring coefficient concerning methanol barring is 1.56, which has a 56% improvement. Although the proton conducting coefficient is reduced a little, its relational selective coefficient, reflecting its whole performance, is 1.366, which has a 36.6% improvement. On comparing to test film #5, which is not a precursor irradiated but is acidified Nafion 117 irradiated by gamma ray with the same dose and rate, test film #1 has better values of D, RBC and RS.

Test film #2 has an irradiation rate of 0.5 kGy/hr an irradiation time of 20 hr and a total irradiating dose of 10 kGy; and the following data are obtained: PC=0.078 S/cm, RPC=1.026, D=9.13×10⁻⁷ cm²/sec, RBC=1.64 and RS=1.651. On comparing to contrast film #10, its relational barring coefficient concerning methanol barring is 1.61, which has a 61% improvement. Although the proton conducting capability is the same, its relational selective coefficient, reflecting its whole performance, is 1.651, which has a 65.1% improvement. On comparing to test film #6, test film #2 has better values of D, RBC and RS.

Test film #3 has an irradiation rate of 0.1 kGy/hr, an irradiation time of 10 hr and a total irradiating dose of 1 kGy; and the following data are obtained: PC=0.076 S/cm, RPC=0.996, D=9.69×10⁻⁷ cm² sec, RBC=1.52 and RS=1.511. On comparing to contrast film #10, its relational barring coefficient is 1.52, which has a 52% improvement. Although the proton conducting caability is the same, its relational selective coefficient is 1.511, which has a 51.1% improvement. On comparing to test film #7, test film #3 has better values of D, RBC and RS.

Test film #4 has an irradiation rate of 0.1 kGy/hr, an irradiation time of 1 hr and a total irradiating dose of 0.1 kGy and the following data are obtained: PC=0.157 S/cm², RPC=2.063, D=1.23×10⁻⁶ cm²/sec, RBC=1.19 and RS=2.456. On comparing to contrast film #10, its relational barring coefficient is 1.19, which has a 19% improvement. Test film #4 has a better proton conducting capacity with a relational selective coefficient of 2.456, which has a 145% improvement. On comparing to test film #8, test film #4 has better values of D, RBC and RS.

Test film #5 is Nafion 117, not a precursor, irradiated by gamma ray in the same way as test film #1; and the following data are obtained: PC=0.099 S/cm, RPC=1.298, D=2.06×10⁻⁶ cm²/sec, RBC=0.71 and RS=0.928.

Test film #6 is non-precursor Nafion 117 irradiated by gamma ray in the same way as test film #2; and the following data are obtained: PC=0.102 S/cm, RPC=1.334, D=1.66×10⁻⁶ cm²/sec, RBC=0.89 and RS=1.128.

Test film #7 is non-precursor Nafion 117 irradiated by gamma ray in the same way as test film #3; and the following data are obtained: PC=0.103 S/cm, RPC=1.348, D=1.37×10⁻⁶ cm²/sec, RBC=1.08 and RS=1.452.

Test film #8 is non-precursor Nafion 117 irradiated by gamma ray in the same way as test film #4; and the following data are obtained: PC=0.113 S/cm, RPC=1.479, D=1.47×10⁻⁶ cm²/sec, RBC=1 and RS=1.48.

Test film #9 has an irradiation rate of 0.5 kGy/h r, an irradiation time of 200 hr and an irradiation dose of 100 kGy. As a result, the film is apt to be worn out, no more suitable for analysis.

Contrast film #10 is a standard contrast set, which is a non-irradiated Nafion 117; and the following data for reference are obtained: PC=0.075 S/cm and D=1.47×10⁻⁶ cm²/sec

The above test films of Nafion R1100 having various radiation rates have lower methanol diffusion coefficients than that of non-irradiated Nafion 117. A lower methanol diffusion coefficient means a better methanol barring, where the Nafion R1100 irradiated with a rate of 0.5 kGy/hr and a dose of 10 kGy has a best relational barring coefficient (RBC=1.61) and the barring achieves a 61% improvement than that of Nafion 117.

To sum up, the present invention is a method for fabricating a proton exchange membrane having a relational selective coefficient, where methanol diffusion coefficient is diminished; methanol barring is improved; relational selective coefficient is increased; and the method is easy and is suitable for fabricating a film in a fuel cell using methanol.

The preferred embodiments herein disclosed are not intended to unnecessarily limit the scope of the invention. Therefore, simple modifications or variations belonging to the equivalent of the scope of the claims and the instructions disclosed herein for a patent are all within the scope of the present invention.

What is claimed is:

1. A method for fabricating a proton exchange membrane (PEM) having a relational selective coefficient, comprising steps of:
(a) obtaining a substrate of a precursor, said precursor being a PEM before ionizing;
(b) processing an ionizing radiation to said substrate and
(c) processing a hydrogen ion conversion to an end group of a branch chain of said precursor through an alkaline washing, a water washing and an acid washing to obtain a PEM having a relational selective coefficient.

2. The method according to claim 1,
wherein said PEM is made of a fluorocarbon polymer; and
wherein said precursor is an intermediate product on fabricating said PEM.

3. The method according to claim 2,
wherein said end group is selected from a group consisting of a sulfonamide fluoride group (—SO₂F), a sulfonamide chloride group (—SO₂Cl) and a sulfonamide bromide group (—SO₂Br).

4. The method according to claim 1,
wherein said alkaline washing uses an alkali metal hydroxide to process a process selected from a group consisting of soaking and washing.

5. The method according to claim 1,
wherein said acid washing uses an inorganic strong acid to process a process;
wherein said inorganic strong acid is selected from a group con si sting of sulfuric acid (H₂SO₄), nitric acid (HNO₃) and hydrochloric acid (HCl); and
wherein said process is selected from a group consisting of soaking and washing.

6. The method according to claim 1,
wherein said ionizing radiation has a total radiation dose less than 50 kilo-grays (kGy).

7. The method according to claim 1,
wherein said ionizing radiation has an irradiation rate less than 5 kGy per hour (kGy/hr

8. The method according to claim 1,
wherein said ionizing radiation uses X ray.

9. The method according to claim 1,
wherein said ionizing radiation uses gamma ray.

10. The method according to claim 9,
wherein said gamma ray is a cobalt-60 (Co-60) gamma ray.

11. A method for fabricating a PEM having a relational selective coefficient, comprising steps of:
(a) obtaining a substrate of a PEM; and
(b) processing an ionizing radiation to said substrate to obtain a PEM having a relational selective coefficient.

12. The method according to claim 11
wherein said PEM is made of a fluorocarbon polymer.

13. The method according to claim 12,
wherein an end group of a branch chain of said fluorocarbon polymer is sulfonic acid group (—SO₃H).

14. The method according to claim 11,
wherein said ionizing radiation has a total radiation dose less than 50 kGy.

15. The method according to claim 11,
wherein said ionizing radiation has an irradiation rate less than 5 kGy/hr

16. The method according to claim 11,
wherein said ionizing radiation uses X ray.

17. The method according to claim 11,
wherein said ionizing radiation uses gamma ray.

18. The method according to claim 17,
wherein said gamma ray is a Co-60 gamma ray.
